(19) United States
(12) Patent Application Publication
(10) Pub. No.: US 2026/0302176 A1
(43) Pub. Date: Oct. 1, 2026

(54) SOLID-STATE BATTERY AND METHOD FOR PRODUCING SOLID-STATE BATTERY

(71) Applicant: HONDA MOTOR CO., LTD., Tokyo (JP)

(72) Inventors: Takamitsu ONUMA, Saitama (JP); Takafumi NAGAI, Saitama (JP)

(21) Appl. No.: 19/422,464

(22) Filed: Dec. 17, 2025

(30) Foreign Application Priority Data
Mar. 31, 2025 (JP) 2025-059477

(51) Int. Cl. H01M 4/36; H01M 4/02; H01M 4/04; H01M 4/134; H01M 4/62; H01M 10/0562

(52) U.S. Cl. CPC H01M 4/364; H01M 4/0433; H01M 4/0471; H01M 4/134; H01M 4/625; H01M 10/0562; H01M 2004/021; H01M 2004/027; H01M 2300/0022

(57) ABSTRACT

Provided is a solid-state battery, including: a negative electrode mixture layer including a silicon-based active material and a solid electrolyte; and a solid electrolyte layer including a sulfide solid electrolyte, in which the solid electrolyte included in the negative electrode mixture layer includes a boron cluster anion and a metal cation and does not include an organic cation.

This application is based on and claims the benefit of priority from Japanese Patent Application No. 2025-059477, filed on 31 Mar. 2025, the content of which is incorporated herein by reference.

### BACKGROUND OF THE INVENTION

### Field of the Invention

The present invention relates to a solid-state battery and a method for producing the solid-state battery.

### Related Art

In recent years, research and development concerning solid-state batteries that contribute to energy efficiency has been conducted to enable more people to access affordable, reliable, sustainable, and advanced energy.

Japanese Unexamined Patent Application, Publication No. 2022-11539 discloses a solid-state battery including a positive electrode layer, a negative electrode layer, and a solid electrolyte layer formed between the positive electrode layer and the negative electrode layer. Here, the negative electrode layer contains a boron hydride compound.
Patent Document 1: Japanese Unexamined Patent Application, Publication No. 2022-11539

### SUMMARY OF THE INVENTION

However, the solid-state battery described in Japanese Unexamined Patent Application, Publication No. 2022-11539 may have a lower initial coulombic efficiency.

An object of the present invention is to provide a solid-state battery having a high initial coulombic efficiency.
(1) A solid-state battery, including: a negative electrode mixture layer including a silicon-based active material and a solid electrolyte; and a solid electrolyte layer including a sulfide solid electrolyte, in which the solid electrolyte included in the negative electrode mixture layer includes a boron cluster anion and a metal cation and does not include an organic cation.
(2) The solid-state battery according to (1), in which the solid electrolyte included in the negative electrode mixture layer is a lithium salt of a carborane anion expressed by the general formula:

Liₐ(C_{b}B_{c}H_{d})

where a is an integer of 1 or more and 5 or less, b is an integer of 0 or more and 5 or less, c is an integer of 1 or more and 20 or less, and d is an integer of 1 or more and 20 or less.
(3) The solid-state battery according to (2), in which the lithium salt of a carborane anion includes Li(CB₉H₁₀) and Li(CB₁₁H₁₂), and a molar ratio of Li(CB₉H₁₀) to Li(CB₁₁H₁₂) is more than 0.1 and equal to or less than 10.
(4) The solid-state battery according to any one of (1) to (3), in which an amount of the solid electrolyte included in the negative electrode mixture layer is 20 volumes or more and 80 volume % or less.
(5) The solid-state battery according to any one of (1) to (4), in which a volume ratio of the solid electrolyte to the silicon-based active material in the negative electrode mixture layer is 0.40 or more and 7.0 or less.
(6) The solid-state battery according to any one of (1) to (5), in which the negative electrode mixture layer further includes a conductive aid.
(7) The solid-state battery according to (6), in which a volume ratio of the conductive aid to the solid electrolyte in the negative electrode mixture layer is 0.010 or more and 0.30 or less.
(8) The solid-state battery according to (6) or (7), in which the conductive aid includes carbon black.
(9) The solid-state battery according to any one of (1) to (8), in which the negative electrode mixture layer has a thickness of 10 μm or more and 200 μm or less.
(10) The solid-state battery according to any one of (1) to (9), in which the sulfide solid electrolyte is an argyrodite-type sulfide solid electrolyte.
(11) A method for producing the solid-state battery according to any one of (1) to (10), the method including: mixing a composition including the silicon-based active material and the solid electrolyte at a temperature of 120° C. or lower to provide a negative electrode mixture; and press-molding the negative electrode mixture to form the negative electrode mixture layer.

According to an embodiment of the present invention, it is possible to provide a solid-state battery having a high initial coulombic efficiency.

### DETAILED DESCRIPTION OF THE INVENTION

Hereinafter, embodiments of the present invention is described.

### [Solid-State Battery]

A solid-state battery of the present embodiment includes a negative electrode mixture layer including a silicon-based active material and a solid electrolyte, and a solid electrolyte layer including a sulfide solid electrolyte. Here, the solid electrolyte included in the negative electrode mixture layer includes a boron cluster anion and a metal cation and does not include an organic cation. Because of this, the solid-state battery of the present embodiment has a high initial coulombic efficiency, which results in high energy density in the solid-state battery of the present embodiment. Examples of the organic cation include, but are not particularly limited to, quaternary ammonium ions, and phosphonium ions.

The solid electrolyte included in the negative electrode mixture layer is preferably a lithium salt of a carborane anion expressed by the general formula:

Liₐ(C_{b}B_{c}Ha)

where a is an integer of 1 or more and 5 or less, b is an integer of 0 or more and 5 or less, c is an integer of 1 or more and 20 or less, and d is an integer of 1 or more and 20 or less. As a result, the solid-state battery of the present embodiment has a high initial coulombic efficiency even when the solid electrolyte is not melted during formation of the negative electrode mixture layer.

It is preferable that c is d−1. In this case, d is preferably 5 or more and 15 or less, and more preferably 8 or more and 14 or less. Examples of the lithium salt of a carborane anion where c is d−1 include Li(CB₇H₈), Li(CB₈H₉), Li(CB₉H₁₀), Li(CB₁₀H₁₁), Li(CB₁₁H₁₂), Li(CB₁₂H₁₃), and Li(CB₁₃H₁₄). Among these, Li(CB₉H₁₀), Li(CB₁₀H₁₁) and Li(CB₁₁H₁₂) are preferable in terms of productivity.

The lithium salt of a carborane anion preferably includes Li(CB₉H₁₀) and Li(CB₁₁H₁₂), and the molar ratio of Li(CB₉H₁₀) to Li(CB₁₁H₁₂) is preferably more than 0.1 and equal to or less than 10. This increases the initial coulombic efficiency of the solid-state battery of the present embodiment. In this case, the molar ratio of Li(CB₉H₁₀) to Li(CB₁₁H₁₂) is more preferably 0.2 or more and 5 or less.

The amount of the solid electrolyte included in the negative electrode mixture layer is preferably 20 volumes or more and 80 volumes or less, more preferably 25 volumes or more and 75 volume % or less, and particularly preferably 40 volume % or more and 70 volumes or less. When the amount of the solid electrolyte included in the negative electrode mixture layer is 20 volumes or more, the solid-state battery of the present embodiment has a high ion conductivity, whereas when the amount is 80 volumes or less, the solid-state battery of the present embodiment has a high energy density.

A volume ratio of the solid electrolyte to the silicon-based active material in the negative electrode mixture layer is preferably 0.40 or more and 7.0 or less, more preferably 0.50 or more and 4.0 or less, and particularly preferably 0.70 or more and 2.5 or less. When the volume ratio of the solid electrolyte to the silicon-based active material included in the negative electrode mixture layer is 0.4 or more, the solid-state battery of the present embodiment has a high ion conductivity, whereas when the volume ratio is 7 or less, the solid-state battery of the present embodiment has a high energy density.

Examples of the silicon-based active material include, but are not particularly limited to, elemental silicon, silicon alloys, silicon oxides, and composites including silicon and a different element that is different from silicon. Examples of silicon alloys include SiC, SiN, SiTi, SiAl, SiLi, SiCu, and examples of silicon oxides include SiO. Examples of the composites that include silicon and a different element that is different from silicon include a silicon-lithium composite, a silicon-carbon composite, and a silicon-aluminum composite. The composites including silicon and a different element that is difference from silicon may be silicon alloys and may not be silicon alloys.

The negative electrode mixture may preferably further include a conductive aid. This increases the initial coulombic efficiency and initial discharge capacity of the solid-state battery of the present embodiment.

A volume ratio of the conductive aid to the solid electrolyte in the negative electrode mixture layer is preferably 0.010 or more and 0.30 or less, more preferably 0.10 or more and 0.30 or less, and particularly preferably 0.10 or more and 0.25 or less. When the volume ratio of the conductive aid to the solid electrolyte in the negative electrode mixture layer is 0.01 or more, the solid-state battery of the present embodiment has a high electron conductivity, whereas when the volume ratio is 0.30 or less, the solid-state battery of the present embodiment has a high energy density.

Examples of the conductive aid include, but are not particularly limited to, carbon materials, and metal materials. Examples of the carbon materials include carbon black, acetylene black (AB), Ketjenblack (KB), carbon nanotubes (CNT), metallic carbon nanotubes (MCNT), semiconductor carbon nanotubes (SCNT), and carbon nanofibers (CNF). Examples of the metal materials include Ni, Cu, Fe, and stainless steel (SUS). Examples of the shape of conductive materials include spherical and fibrous shapes. Among these, carbon black is preferable in terms of the initial coulombic efficiency and an initial discharge capacity of the solid-state battery of the present embodiment

The negative electrode mixture layer may further include a binder. Examples of the binder include, but are not particularly limited to, fluorine resin binders made of polyvinylidene fluoride (PVDF), polytetrafluoroethylene (PTFE), polyvinylidene fluoride-polyhexafluoropropylene copolymer (PVDF-HFP), fluororubber, and the like, and non-fluororubber binders made of butadiene rubber, hydrogenated butadiene rubber, styrene-butadiene rubber (SBR), hydrogenated styrene-butadiene rubber, nitrile-butadiene rubber, hydrogenated nitrile-butadiene rubber, ethylene propylene rubber, and the like. An acrylic binder may also be used as a binder.

The thickness of the negative electrode mixture layer is preferably 10 μm or more and 200 μm or less, more preferably 15 μm or more and 50 μm or less, and particularly preferably 15 μm or more and 40 μm or less. When the thickness of the negative electrode mixture layer is 10 μm or more, the solid-state battery of the present embodiment has a high initial coulombic efficiency, whereas when thickness of the negative electrode mixture layer is 200 μm or less, the solid-state battery of the present embodiment has a high energy density.

The negative electrode mixture layer is preferably formed by mixing a composition including the silicon-based active material and the solid electrolyte at a temperature of 120° C. or lower to provide a negative electrode mixture, and then press-molding the negative electrode mixture. This reduces the energy consumed when the negative electrode mixture layer is formed. At this time, the temperature used to mix the composition is more preferably 100° C. or lower, further more preferably 80° C. or lower, even more preferably 60° C. or lower, and particularly preferably 40° C. or lower. Here, the temperature to mix the composition is, for example, 10° C. or higher. The pressure used to press-mold the negative electrode mixture is not particularly limited and may be, for example, 1 MPa or more and 980 MPa or less. When the composition is mixed, a small amount of a dispersion medium may be added to perform wet mixing, though dry mixing is preferable.

The sulfide solid electrolyte included in the solid electrolyte layer includes, for example, a metal element (M) to be a conductive ion, and sulfur(S). Examples of the metal element M include Li, Na, K, Mg, and Ca. Among these, Li is preferable.

The sulfide solid electrolyte preferably includes Li, A that is at least one element selected from the group consisting of P, Si, Ge, Al, and B, and S, and more preferably includes Li and P. Here, the sulfide solid electrolyte may further include a halogen element (e.g., Cl, Br, and I) in terms of ion conductivity. The sulfide solid electrolyte may further include O.

Examples of the sulfide solid electrolyte include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, and Z is one selected from Ge, Zn, and Ga), Li₂S—GeS₂, Li₂S—SiS₂—Li₃PO₄, Li₂S—SiS₂-LiₓMO_{y} (where x and y are positive numbers and M is one selected from P, Si, Ge, B, Al, Ga and In), LiᵥP_{w}SₓCl_{y}Br_{z} (V, w, x, y, z>0). Among these, LiᵥP_{w}SₓCl_{y}Br_{z} (v, W, x, y, z>0) is preferable because the reaction resistance is low even after repeated charge and discharge, LiᵥP_{w}SₓCl_{y}Br_{z} (0<v<10, 0<w<5, 0<x<5, 0<y<5, 0<z<5) is more preferable in terms of ionic conductivity, and Li_{5.4}PS_{4.4}C_{10.8}Br_{0.8} may be included in the examples of the sulfide solid electrolyte.

Note that the description of, for example, “Li₂S—P₂S₅” refers to a sulfide solid electrolyte formed by using a raw material composition including Li₂S and P₂S₅, and the same applies to other descriptions.

The sulfide solid electrolyte may also be a sulfide glass and a crystallized sulfide glass, and may also be a crystalline material obtained by a solid phase method. Here, the sulfide glass can be obtained by performing a mechanical milling method (for example, a method of milling using a ball mill) on raw material compositions. The crystallized sulfide glass is obtained, for example, by heat treatment of the sulfide glass at a temperature that is the crystallization temperature or higher.

The sulfide solid electrolyte included in the solid electrolyte layer is preferably an argyrodite-type sulfide solid electrolyte. This increases the initial coulombic efficiency and initial discharge capacity of the solid-state battery of the present embodiment.

Examples of the form of the solid electrolyte include, but are not particularly limited to, particles.

The amount of the solid electrolyte included in the solid electrolyte layer is not particularly limited, and may be, for example, 50 mass % or more and 99 mass % or less.

The solid electrolyte layer may further include a binder, or the like.

Examples of the method of forming the solid electrolyte layer include, but are not particularly limited to, the method of press-molding a composition including the sulfide solid electrolyte.

The thickness of the solid electrolyte layer is not specifically limited and may be, for example, 0.1 μm or more and 1000 μm or less.

The solid-state battery of the present embodiment further includes, for example, a negative electrode current collector and a positive electrode. Examples of the solid-state battery include, but are not particularly limited to, an all-solid-state lithium ion secondary battery, and a semi-solid-state lithium-ion secondary battery.

Examples of materials that constitute the negative electrode current collector include, but are not particularly limited to, silver, palladium, gold, platinum, aluminum, copper, nickel, stainless steel, and carbon. Among these, copper, stainless steel, and nickel are preferable in terms of conductivity and cost.

Examples of the shape of the negative electrode current collector include, but are not particularly limited to, a foil shape, a plate shape, a mesh shape, a nonwoven fabric shape, and a foamed shape.

The thickness of the negative electrode current collector is not particularly limited and may be, for example, 0.1 μm or more and 1 mm or less.

The positive electrode has, for example, a positive electrode mixture layer formed on a positive electrode current collector.

The positive electrode mixture layer includes a positive electrode active material. Examples of the positive electrode active material include, but are not particularly limited to, lithium cobaltate (LiCo₂), lithium nickelate (LiNiO₂), LiNiₚMn_{q}COᵣO₂ (p+q+r=1), LiNiₚAl_{q}COᵣO_{z} (p+q+r=1), lithium manganate (LiMn₂O₄), Li₁₊ₓMn_{2-x-y}M_{y}O₄ (x+y=2) (where M is at least one element selected from the group consisting of Al, Mg, Co, Fe, Ni, and Zn), lithium titanate, and LiMPO₄ (where M is at least one element selected from the group consisting of Fe, Mn, Co, and Ni).

The amount of the positive electrode active material included in the positive electrode mixture layer may be 20 mass % or more, 30 mass % or more, and 40 mass % or more. On the other hand, the amount of the positive electrode active material included in the positive electrode mixture layer may be 99% or less, 90 mass % or less, 80 mass % or less, and 70 mass % or less.

The positive electrode mixture layer may further include a solid electrolyte. The solid electrolyte may be, but is not particularly limited to, any suitable material capable of conducting lithium ions, such as oxide solid electrolyte, and sulfide solid electrolyte.

The positive electrode mixture layer may further include a binder, a conductive aid, or the like.

The thickness of the positive electrode mixture layer is not particularly limited and may be, for example, 0.1 μm or more and 1000 μm or less.

Examples of the method of forming the positive electrode mixture layer include, but are not particularly limited to, a method of applying a slurry including a positive electrode active material and a solvent.

The materials that constitute the positive electrode current collector may be, but are not particularly limited to, any suitable material having conductivity, such as aluminum, aluminum alloys, stainless steel, nickel, iron, and titanium. Among these, aluminum, aluminum alloys, and stainless steel are preferable.

Examples of the shape of the positive electrode current collector include, but are not particularly limited to, a foil shape and a plate shape.

The solid-state battery of the present embodiment can be produced by well-known methods. For example, the solid-state battery of the present embodiment can be produced by sequentially stacking a negative electrode current collector, a negative electrode mixture layer, a solid electrolyte layer, a positive electrode mixture layer, and a positive electrode current collector into a stacked body, and then press-molding and integrating the stacked body.

Although the embodiment of the present invention has been described in the foregoing, the present invention is not limited to the embodiment disclosed above, and the embodiment may be changed as appropriate within the scope of the present invention.

### EXAMPLES

Hereinafter, examples of the present invention will be described, though the present invention is not limited thereto.

### Example 1

As described below, a negative electrode mixture layer, a solid electrolyte layer, and a half-cell were produced in a glove box, the inside of which was replaced with nitrogen.

### (Production of Negative Electrode Mixture Layer)

A negative electrode mixture was obtained by dry-mixing 32 parts by mass of silicon (made by Aldrich) having a median diameter (D₅₀) of 200 μm, 57 parts by mass of lithium salt of a carborane anion, and 11 parts by mass of carbon black at 25° C. with use of a planetary centrifugal mixer so that a volume ratio of an active material, a solid electrolyte, and a conductive aid was 29:64.5:6.5. At that time, the lithium salt of a carborane anion was not melted as the molar ratio between Li(CB₉H₁₀) and Li(CB₁₁H₁₂) was 7:3. Then, the negative electrode mixture was press-molded at a pressure of 27 MPa to provide a negative electrode mixture layer with a thickness of 21.5 μm.

### (Production of Solid Electrolyte Layer)

A solid electrolyte layer was obtained by press-molding an argyrodite-type sulfide solid electrolyte (Li_{5.4}PS_{4.4}Cl_{0.8}Br_{0.8}) having a median diameter (D₅₀) of 700 nm at a pressure of 27 MPa.

### (Production of Half-Cell)

A copper foil, a negative electrode mixture layer, a solid electrolyte layer, an indium foil, a lithium foil, and a copper foil were sequentially stacked on a cylindrical container with an inner diameter of 10 mm, and in this state, the cylindrical container were press-molded under the conditions of a temperature of 25° C. and a pressure of 10 tons, then clamped with a stainless steel jig, and restrained at a pressure of 60 MPa to provide a half-cell.

### Example 2

A half-cell was obtained in the same way as in Example 1, except that a silicon/carbon composite was used instead of the silicon (made by Aldrich) having a median diameter (D₅₀) of 200 μm. At that time, the thickness of the negative electrode mixture layer was 24.7 μm.

### Example 3

A half-cell was obtained in the same way as in Example 1 except that 44.5 parts by mass of silicon (made by Aldrich) having a median diameter (D₅₀) of 200 μm, 44.5 parts by mass of lithium salt of a carborane anion, and 11 parts by mass of carbon black were dry-mixed so that a volume ratio of an active material, a solid electrolyte, and a conductive aid was 40:50:10. At that time, the thickness of the negative electrode mixture layer was 25.2 μm.

### Example 4

A half-cell was obtained in the same way as in Example 1 except that 54 parts by mass of silicon (made by Aldrich) having a median diameter (D₅₀) of 200 μm, 35 parts by mass of lithium salt of a carborane anion, and 11 parts by mass of carbon black were dry-mixed so that a volume ratio of an active material, a solid electrolyte, and a conductive aid was 50:40:10. At that time, the thickness of the negative electrode mixture layer was 25.8 μm.

### Comparative Example 1

A negative electrode was obtained in the same way as in Example 2, except that an argyrodite-type sulfide solid electrolyte (Li_{5.4}PS_{4.4}Cl_{0.8}Br_{0.8}) having a median diameter (D₅₀) of 700 nm was used instead of 39.9 parts by mass of Li(CB₉H₁₀) and 17.1 parts by mass of Li(CB₁₁H₁₂). At that time, the thickness of the negative electrode mixture layer was 20.0 μm.

### [Initial Coulombic Efficiency]

A charge-discharge test for the half-cells was conducted. Specifically, the initial coulombic efficiency (a ratio of first discharge capacity to first charge capacity) was evaluated by charging up to −0.6 V with a constant current of 0.38 mA/cm², pausing for 10 minutes, and discharging up to 0.9 V with a constant current of 0.38 mA/cm².

### [Discharge Capacity Retention Rate]

The charge-discharge test of the half-cells was conducted 10 times under the same conditions as in the measurement of the initial coulombic efficiency, and the discharge capacity was measured. Then, a ratio of discharge capacity to initial discharge capacity after the charge-discharge test was conducted 10 times was calculated as a discharge capacity retention ratio.

Table 1 shows the evaluation results of the initial coulombic efficiency and the discharge capacity retention ratio of the half-cells.

TABLE 1

| | Negative electrode | | Initial | Initial | Initial | Discharge |
|---|---|---|---|---|---|---|
| | mixture layer | | discharge | charge | coulombic | capacity |
| | Active | Solid | capacity | capacity | efficiency | retention |
| | material | electrolyte | [mAh/g] | [mAh/g] | [%] | ratio [%] |
| Example 1 | Si | Li(CB₉H₁₀) | 3514.7 | 3412.5 | 90.0 | 97.3 |
| | | Li(CB₁₁H₁₂) | | | | |
| Example 2 | Si/C | Li(CB₉H₁₀) | 1864.5 | 2186.3 | 85.3 | — |
| | | Li(CB₁₁H₁₂) | | | | |
| Example 3 | Si | Li(CB₉H₁₀) | 2922.0 | 2868.1 | 92.8 | 91.8 |
| | | Li(CB₁₁H₁₂) | | | | |
| Example 4 | Si | Li(CB₉H₁₀) | 2824.2 | 2773.1 | 91.4 | 93.9 |
| | | Li(CB₁₁H₁₂) | | | | |
| Comparative | Si/C | Sulfide solid | 1896.8 | 2387.6 | 79.4 | — |
| Example 1 | | electrolyte | | | | |

Table 1 shows that the half-cells in Examples 1 to 4 have a high initial coulombic efficiency. The half-cells in Examples 1, 3, and 4 also have a high discharge capacity retention ratio. Note that the half-cell in Example 1 had a discharge capacity retention ratio of 94.6% when the charge-discharge test was conducted 20 times. On the other hand, the half-cell in the comparative example 1 had a low initial coulombic efficiency since the solid electrolyte included in the negative electrode mixture layer was a sulfide solid electrolyte.

What is claimed is:

1. A solid-state battery comprising:
a negative electrode mixture layer including a silicon-based active material and a solid electrolyte; and
a solid electrolyte layer including a sulfide solid electrolyte, wherein
the solid electrolyte included in the negative electrode mixture layer includes a boron cluster anion and a metal cation and does not include an organic cation.

2. The solid-state battery according to claim 1, wherein the solid electrolyte included in the negative electrode mixture layer is a lithium salt of a carborane anion expressed by the general formula: 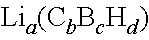
where a is an integer of 1 or more and 5 or less, b is an integer of 0 or more and 5 or less, c is an integer of 1 or more and 20 or less, and d is an integer of 1 or more and 20 or less.

3. The solid-state battery according to claim 2, wherein the lithium salt of a carborane anion includes Li(CB₉H₁₀) and Li(CB₁₁H₁₂), and a molar ratio of Li(CB₉H₁₀) to Li(CB₁₁H₁₂) is more than 0.1 and equal to or less than 10.

4. The solid-state battery according to claim 1, wherein an amount of the solid electrolyte included in the negative electrode mixture layer is 20 volumes or more and 80 volumes or less.

5. The solid-state battery according to claim 1, wherein a volume ratio of the solid electrolyte to the silicon-based active material in the negative electrode mixture layer is 0.40 or more and 7.0 or less.

6. The solid-state battery according to claim 1, wherein the negative electrode mixture layer further includes a conductive aid.

7. The solid-state battery according to claim 6, wherein a volume ratio of the conductive aid to the solid electrolyte in the negative electrode mixture layer is 0.010 or more and 0.30 or less.

8. The solid-state battery according to claim 6, wherein the conductive aid includes carbon black.

9. The solid-state battery according to claim 1, wherein the negative electrode mixture layer has a thickness of 10 μm or more and 200 μm or less.

10. The solid-state battery according to claim 1, wherein the sulfide solid electrolyte is an argyrodite-type sulfide solid electrolyte.

11. A method for producing the solid-state battery according to claim 1, the method comprising:
mixing a composition including the silicon-based active material and the solid electrolyte at a temperature of 120° C. or lower to provide a negative electrode mixture; and
press-molding the negative electrode mixture to form the negative electrode mixture layer.
